(19) United States
(12) Patent Application Publication
(10) Pub. No.: US 2022/0177000 A1
(43) Pub. Date: Jun. 9, 2022

(54) IDENTIFICATION OF DRIVING MANEUVERS TO INFORM PERFORMANCE GRADING AND CONTROL IN AUTONOMOUS VEHICLES

(71) Applicant: GM GLOBAL TECHNOLOGY OPERATIONS LLC, Detroit, MI (US)

(72) Inventors: Iman Zadeh, Los Angeles, CA (US); Rajan Bhattacharyya, Sherman Oaks, CA (US); Vincent De Sapio, Westlake Village, CA (US); Amir M. Rahimi, Santa Monica, CA (US)

(21) Appl. No.: 17/110,783

(22) Filed: Dec. 3, 2020

(51) Int. Cl. B60W 60/00; B60W 50/06; B60W 50/10; G06N 20/00

(52) U.S. Cl. CPC B60W 60/0027; G06N 20/00; B60W 50/10; B60W 50/06

(57) ABSTRACT

An autonomous vehicle and a system and method of operating the autonomous vehicle. A maneuver classifier is trained at an offline processor to identify a driving maneuver for a driving context. An online processor is configured to receive the driving context, operate the maneuver classifier to identify the driving maneuver based on the driving context, perform the driving maneuver at the autonomous vehicle, grade the driving maneuver as it is being performed at the autonomous vehicle, and adjust a performance of the driving maneuver at the autonomous vehicle based on the grade. The online processor is included in the autonomous vehicle

### INTRODUCTION

The subject disclosure relates to a system and method for operating an autonomous vehicle and, in particular, a system and method for performing a maneuver at the autonomous vehicle based on a performance grade assigned to the maneuver in order to improve operation of the autonomous vehicle.

An autonomous vehicle operates by detecting objects in its environment or environmental conditions and performing an action in response. Generally, the autonomous vehicle uses a set of instructions that enable the vehicle to react to traffic conditions according to a system-defined behavior. However, this set of instructions does not take into account different driving contexts that are encountered by the autonomous vehicle and does not allow the vehicle to adjust its behavior based on the driving context. Accordingly, it is desirable to provide a system capable of performing a driving maneuver according to a behavior that is suitable for a driving scenario.

### SUMMARY

In one exemplary embodiment, a method of operating an autonomous vehicle is disclosed. A maneuver classifier is trained to identify a driving maneuver for a driving context. The driving context is received at the maneuver classifier. The driving maneuver is identified at the maneuver classifier based on the driving context. The driving maneuver is performed at the autonomous vehicle. The driving maneuver is graded as it is being performed at the autonomous vehicle to obtain a grade. A performance of the driving maneuver is adjected at the autonomous vehicle based on the grade.

In addition to one or more of the features described herein, training the maneuver classifier includes creating a cluster for each of a plurality of driving maneuvers identified from a historical database of driving maneuvers. The method further includes labelling the cluster of the plurality of driving maneuvers. The cluster is labelled by a human. The driving context includes a speed of the autonomous vehicle and a heading of the autonomous vehicle. The method further includes assigning a grade to a road user other than the autonomous vehicle and adjusting a prediction of a trajectory of the road user based on the grade for the road user. Grading the driving maneuver further includes assigned a performance grade specific to the driving context.

In another exemplary embodiment, a system for operating an autonomous vehicle is disclosed. The system includes an offline processor and an online processor. The offline processor is configured to train a maneuver classifier to identify a driving maneuver for a driving context. The online processor is configured to receive the driving context, operate the maneuver classifier to identify the driving maneuver based on the driving context, perform the driving maneuver at the autonomous vehicle, grade the driving maneuver as it is being performed at the autonomous vehicle, and adjust a performance of the driving maneuver at the autonomous vehicle based on the grade.

In addition to one or more of the features described herein, the offline processor is configured to train the maneuver classifier by creating a cluster for each of a plurality of driving maneuvers selected from a historical database of driving maneuvers. The offline processor is further configured to label the cluster of the plurality of driving maneuvers. The offline processor is further configured to receive a label for the cluster from a human. The online processor is further configured to receive, as the driving context, a speed of the autonomous vehicle and a heading of the autonomous vehicle. The online processor is further configured to assign a grade to a road user other than the autonomous vehicle and adjust a prediction of a trajectory of the road user based on the grade for the road user. The online processor is further configured to grade the driving maneuver by assigning a performance grade specific to the driving context.

In yet another exemplary embodiment, an autonomous vehicle is disclosed. The autonomous vehicle includes a maneuver classifier trained at an offline processor to identify a driving maneuver for a driving context, and an online processor. The online processor is configured to receive the driving context, operate the maneuver classifier to identify the driving maneuver based on the driving context, perform the driving maneuver at the autonomous vehicle, grade the driving maneuver as it is being performed at the autonomous vehicle, and adjust a performance of the driving maneuver at the autonomous vehicle based on the grade.

In addition to one or more of the features described herein, the offline processor is configured to create a cluster for each of a plurality of driving maneuvers selected from a historical database of driving maneuvers to train the maneuver classifier. The offline processor is further configured to present the cluster of each of the plurality of driving maneuvers to a human and receive a label for the cluster from the human. The online processor is further configured to receive, as the driving context, a speed of the autonomous vehicle and a heading of the autonomous vehicle. The online processor is further configured to assign a grade to a road user other than the autonomous vehicle and adjust a prediction of a trajectory of the road user based on the grade for the road user. The online processor is further configured to grade the driving maneuver by assigning a performance grade specific to the driving context.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with an associated trajectory planning system in accordance with various embodiments;

FIG. 2 shows an illustrative control system including a cognitive processor integrated with an autonomous vehicle;

FIG. 3 shows a schematic diagram of a training system for training a maneuver classifier to be able to respond to a driving scenario by selecting a driving maneuver suitable to the driving scenario;

FIG. 4 shows a schematic diagram of an operating system that is using the trained maneuver classifier to operate the autonomous vehicle through different driving scenarios;

FIG. 5. shows a schematic diagram of a grading system for grading the actions of other road users as evaluated using the maneuver classifier;

FIG. 6 shows illustrative data from a driving dataset for a driving scenario in which a host vehicle passes through an intersection;

FIG. 7 shows a graph depicting illustrative data clusters generated from a plurality of snapshots for a selected driving scenario using a suitable clustering method; and

FIG. 8 shows a graph illustrating cluster assignment over time.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

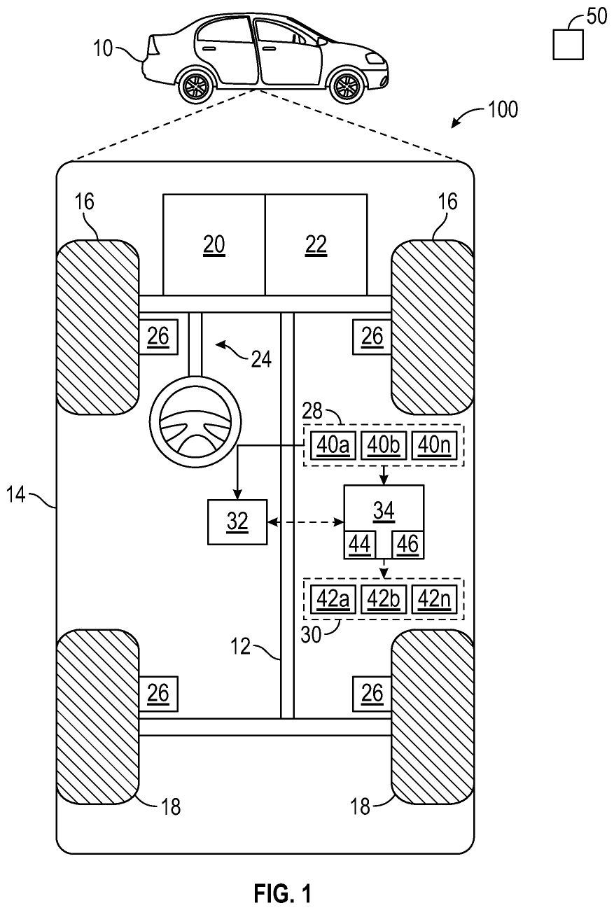

In accordance with an exemplary embodiment, FIG. 1 shows an autonomous vehicle 10 with an associated trajectory planning system depicted at 100 in accordance with various embodiments. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The front wheels 16 and rear wheels 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle 10 can assist the driver through a number of methods, such as warning signals to indicate upcoming risky situations, indicators to augment situational awareness of the driver by predicting movement of other agents warning of potential collisions, etc. The autonomous vehicle 10 has different levels of intervention or control of the vehicle from coupled assistive vehicle control all the way to full control of all vehicle functions. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, a cognitive processor 32, and a controller 34. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes a processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms.

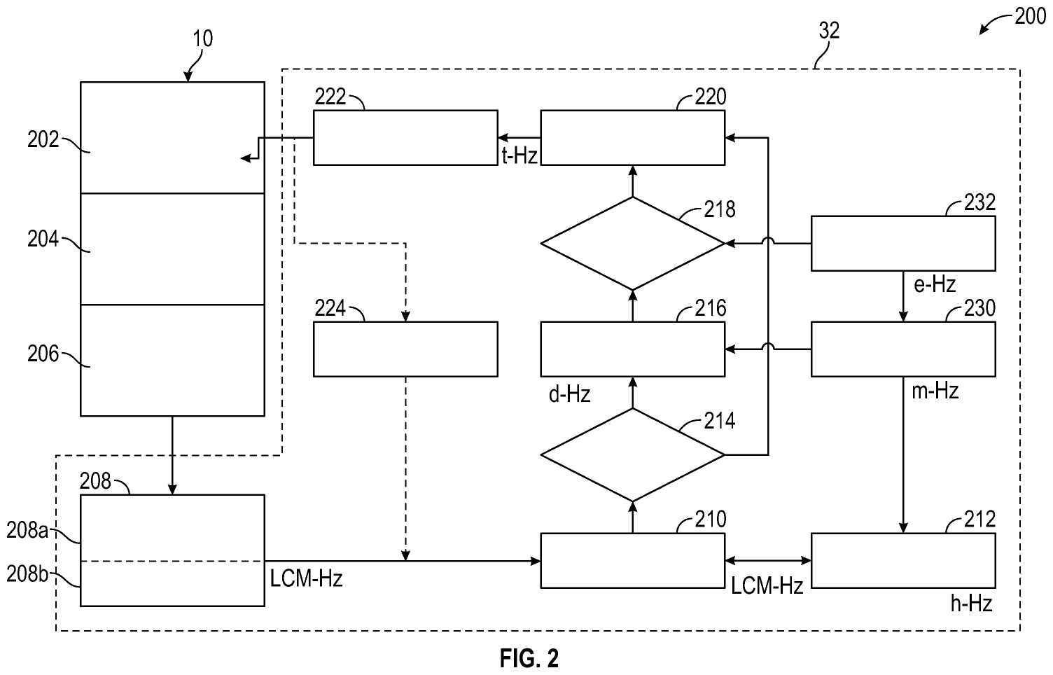

The controller 34 is further in communication with the cognitive processor 32. The cognitive processor 32 receives various data from the controller 34 and from the sensing devices 40a-40n of the sensor system 28 and performs various calculations in order to provide a trajectory to the controller 34 for the controller 34 to implement at the autonomous vehicle 10 via the one or more actuator devices 42a-42n. A detailed discussion of the cognitive processor 32 is provided with respect to FIG. 2.

FIG. 2 shows an illustrative control system 200 including a cognitive processor 32 integrated with an autonomous vehicle 10. In various embodiment the autonomous vehicle 10 can be a vehicle simulator that simulates various driving scenarios for the autonomous vehicle 10 and simulates various response of the autonomous vehicle 10 to the scenarios.

The autonomous vehicle 10 includes a data acquisition system 204 (e.g., sensing devices 40a-40n of FIG. 1). The data acquisition system 204 obtains various data for determining a state of the autonomous vehicle 10 and various agents in the environment of the autonomous vehicle 10. Such data includes, but is not limited to, kinematic data, position or pose data, etc., of the autonomous vehicle 10 as well as data about other agents, including as range, relative speed (Doppler), elevation, angular location, etc. The autonomous vehicle 10 further includes a sending module 206 that packages the acquired data and sends the packaged data to the communication interface or interface module 208 of the cognitive processor 32, as discussed herein. The autonomous vehicle 10 further includes a receiving module 202 that receives operating commands from the cognitive processor 32 and performs the commands at the autonomous vehicle 10 to navigate the autonomous vehicle 10. The cognitive processor 32 receives the data from the autonomous vehicle 10, computes a trajectory for the autonomous vehicle 10 based on the provided state information and the methods disclosed herein and provides the trajectory to the autonomous vehicle 10 at the receiving module 202. The autonomous vehicle 10 then implements the trajectory provided by the cognitive processor 32.

The cognitive processor 32 includes various modules for communication with the autonomous vehicle 10, including an interface module 208 for receiving data from the autonomous vehicle 10 and a trajectory sender 222 for sending instructions, such as a trajectory to the autonomous vehicle 10. The cognitive processor 32 further includes a working memory 210 that stores various data received from the autonomous vehicle 10 as well as various intermediate calculations of the cognitive processor 32. A hypothesizer module(s) 212 of the cognitive processor 32 is used to propose various hypothetical trajectories and motions of one or more agents in the environment of the autonomous vehicle 10 using a plurality of possible prediction methods and state data stored in working memory 210. A hypothesis resolver 214 of the cognitive processor 32 receives the plurality of hypothetical trajectories for each agent in the environment and determines a most likely trajectory for each agent from the plurality of hypothetical trajectories.

The cognitive processor 32 further includes one or more decider modules 216 and a decision resolver 218. The decider module(s) 216 receives the most likely trajectory for each agent in the environment from the hypothesis resolver 214 and calculates a plurality of candidate trajectories and behaviors for the autonomous vehicle 10 based on the most likely agent trajectories. Each of the plurality of candidate trajectories and behaviors is provided to the decision resolver 218. The decision resolver 218 selects or determines an optimal or desired trajectory and behavior for the autonomous vehicle 10 from the candidate trajectories and behaviors.

The cognitive processor 32 further includes a trajectory planner 220 that determines an autonomous vehicle trajectory that is provided to the autonomous vehicle 10. The trajectory planner 220 receives the vehicle behavior and trajectory from the decision resolver 218, an optimal hypothesis for each agent 50 from the hypothesis resolver 214, and the most recent environmental information in the form of “state data” to adjust the trajectory plan. This additional step at the trajectory planner 220 ensures that any anomalous processing delays in the asynchronous computation of agent hypotheses is checked against the most recent sensed data from the data acquisition system 204. This additional step updates the optimal hypothesis accordingly in the final trajectory computation in the trajectory planner 220.

The determined vehicle trajectory is provided from the trajectory planner 220 to the trajectory sender 222 which provides a trajectory message to the autonomous vehicle 10 (e.g., at controller 34) for implementation at the autonomous vehicle 10.

The cognitive processor 32 further includes a modulator 230 that controls various limits and thresholds for the hypothesizer module(s) 212 and decider module(s) 216. The modulator 230 can also apply changes to parameters for the hypothesis resolver 214 to affect how it selects the optimal hypothesis object for a given agent 50, deciders, and the decision resolver. The modulator 230 is a discriminator that makes the architecture adaptive. The modulator 230 can change the calculations that are performed as well as the actual result of deterministic computations by changing parameters in the algorithms themselves.

An evaluator module 232 of the cognitive processor 32 computes and provides contextual information to the cognitive processor including error measures, hypothesis confidence measures, measures on the complexity of the environment and autonomous vehicle 10 state, performance evaluation of the autonomous vehicle 10 given environmental information including agent hypotheses and autonomous vehicle trajectory (either historical, or future). The modulator 230 receives information from the evaluator module 232 to compute changes to processing parameters for hypothesizer(s) 212, the hypothesis resolver 214, the decider module(s) 216, and threshold decision resolution parameters to the decision resolver 218. A virtual controller 224 implements the trajectory message and determines a feedforward trajectory of various agents 50 in response to the trajectory.

Modulation occurs as a response to uncertainty as measured by the evaluator module 232. In one embodiment, the modulator 230 receives confidence levels associated with hypothesis objects. These confidence levels can be collected from hypothesis objects at a single point in time or over a selected time window. The time window may be variable. The evaluator module 232 determines the entropy of the distribution of these confidence levels. In addition, historical error measures on hypothesis objects can also be collected and evaluated in the evaluator module 232.

These types of evaluations serve as an internal context and measure of uncertainty for the cognitive processor 32. These contextual signals from the evaluator module 232 are utilized for the hypothesis resolver 214, decision resolver, 218, and modulator 230 which can change parameters for hypothesizer module(s) 212 based on the results of the calculations.

The various modules of the cognitive processor 32 operate independently of each other and are updated at individual update rates (indicated by, for example, LCM-Hz, h-Hz, d-Hz, e-Hz, m-Hz, t-Hz in FIG. 2).

In operation, the interface module 208 of the cognitive processor 32 receives the packaged data from the sending module 206 of the autonomous vehicle 10 at a data receiver 208a and parses the received data at a data parser 208b. The data parser 208b places the data into a data format, referred to herein as a property bag, that can be stored in working memory 210 and used by the various hypothesizer module(s) 212, decider modules 216, etc. of the cognitive processor 32. The particular class structure of these data formats should not be considered a limitation of the invention.

Working memory 210 extracts the information from the collection of property bags during a configurable time window to construct snapshots of the autonomous vehicle and various agents. These snapshots are published with a fixed frequency and pushed to subscribing modules. The data structure created by working memory 210 from the property bags is a “State” data structure which contains information organized according to timestamp. A sequence of generated snapshots therefore encompasses dynamic state information for another vehicle or agent. Property bags within a selected State data structure contain information about objects, such as other agents, the autonomous vehicle, route information, etc. The property bag for an object contains detailed information about the object, such as the object's location, speed, heading angle, etc. This state data structure flows throughout the rest of the cognitive processor 32 for computations. State data can refer to autonomous vehicle states as well as agent states, etc.

The hypothesizer module(s) 212 pulls State data from the working memory 210 in order to compute possible outcomes of the agents in the local environment over a selected time frame or time step. Alternatively, the working memory 210 can push State data to the hypothesizer module(s) 212. The hypothesizer module(s) 212 can include a plurality of hypothesizer modules, with each of the plurality of hypothesizer modules employing a different method or technique for determining the possible outcome of the agent(s). One hypothesizer module may determine a possible outcome using a kinematic model that applies basic physics and mechanics to data in the working memory 210 in order to predict a subsequent state of each agent 50. Other hypothesizer modules may predict a subsequent state of each agent 50 by, for example, employing a kinematic regression tree to the data, applying a Gaussian Mixture Model/Markovian mixture model (GMM-HMM) to the data, applying a recursive neural network (RNN) to the data, other machine learning processes, performing logic based reasoning on the data, etc. The hypothesizer module(s) 212 are modular components of the cognitive processor 32 and can be added or removed from the cognitive processor 32 as desired.

Each hypothesizer module 212 includes a hypothesis class for predicting agent behavior. The hypothesis class includes specifications for hypothesis objects and a set of algorithms. Once called, a hypothesis object is created for an agent from the hypothesis class. The hypothesis object adheres to the specifications of the hypothesis class and uses the algorithms of the hypothesis class. A plurality of hypothesis objects can be run in parallel with each other. Each hypothesizer module 212 creates its own prediction for each agent 50 based on the working current data and sends the prediction back to the working memory 210 for storage and for future use. As new data is provided to the working memory 210, each hypothesizer module 212 updates its hypothesis and pushes the updated hypothesis back into the working memory 210. Each hypothesizer module 212 can choose to update its hypothesis at its own update rate (e.g., rate h-Hz). Each hypothesizer module 212 can individually act as a subscription service from which its updated hypothesis is pushed to relevant modules.

Each hypothesis object produced by a hypothesizer module 212 is a prediction in the form of a state data structure for a vector of time, for defined entities such as a location, speed, heading, etc. In one embodiment, the hypothesizer module(s) 212 can contain a collision detection module which can alter the feedforward flow of information related to predictions. Specifically, if a hypothesizer module 212 predicts a collision of two agents 50, another hypothesizer module may be invoked to produce adjustments to the hypothesis object in order to take into account the expected collision or to send a warning flag to other modules to attempt to mitigate the dangerous scenario or alter behavior to avoid the dangerous scenario.

For each agent 50, the hypothesis resolver 214 receives the relevant hypothesis objects and selects a single hypothesis object from the hypothesis objects. In one embodiment, the hypothesis resolver 214 invokes a simple selection process. Alternatively, the hypothesis resolver 214 can invoke a fusion process on the various hypothesis objects in order to generate a hybrid hypothesis object.

Since the architecture of the cognitive processor is asynchronous, if a computational method implemented as a hypothesis object takes longer to complete, then the hypothesis resolver 214 and downstream decider modules 216 receive the hypothesis object from that specific hypothesizer module at an earliest available time through a subscription-push process. Time stamps associated with a hypothesis object informs the downstream modules of the relevant time frame for the hypothesis object, allowing for synchronization with hypothesis objects and/or state data from other modules. The time span for which the prediction of the hypothesis object applies is thus aligned temporally across modules.

For example, when a decider module 216 receives a hypothesis object, the decider module 216 compares the time stamp of the hypothesis object with a time stamp for most recent data (i.e., speed, location, heading, etc.) of the autonomous vehicle 10. If the time stamp of the hypothesis object is considered too old (e.g., pre-dates the autonomous vehicle data by a selected time criterion) the hypothesis object can be disregarded until an updated hypothesis object is received. Updates based on most recent information are also performed by the trajectory planner 220.

The decider module(s) 216 includes modules that produce various candidate decisions in the form of trajectories and behaviors for the autonomous vehicle 10. The decider module(s) 216 receives a hypothesis for each agent 50 from the hypothesis resolver 214 and uses these hypotheses and a nominal goal trajectory for the autonomous vehicle 10 as constraints. The decider module(s) 216 can include a plurality of decider modules, with each of the plurality of decider modules using a different method or technique for determining a possible trajectory or behavior for the autonomous vehicle 10. Each decider module can operate asynchronously and receives various input states from working memory 210, such as the hypothesis produced by the hypothesis resolver 214. The decider module(s) 216 are modular components and can be added or removed from the cognitive processor 32 as desired. Each decider module 216 can update its decisions at its own update rate (e.g., rate d-Hz).

Similar to a hypothesizer module 212, a decider module 216 includes a decider class for predicting an autonomous vehicle trajectory and/or behavior. The decider class includes specifications for decider objects and a set of algorithms. Once called, a decider object is created for an agent 50 from the decider class. The decider object adheres to the specifications of the decider class and uses the algorithm of the decider class. A plurality of decider objects can be run in parallel with each other.

The decision resolver 218 receives the various decisions generated by the one or more decider modules and produces a single trajectory and behavior object for the autonomous vehicle 10. The decision resolver can also receive various contextual information from evaluator modules 232, wherein the contextual information is used in order to produce the trajectory and behavior object.

The trajectory planner 220 receives the trajectory and behavior objects from the decision resolver 218 along with the state of the autonomous vehicle 10. The trajectory planner 220 then generates a trajectory message that is provided to the trajectory sender 222. The trajectory sender 222 provides the trajectory message to the autonomous vehicle 10 for implementation at the autonomous vehicle 10, using a format suitable for communication with the autonomous vehicle 10.

The trajectory sender 222 also sends the trajectory message to virtual controller 224. The virtual controller 224 provides data in a feed-forward loop for the cognitive processor 32. The trajectory sent to the hypothesizer module(s) 212 in subsequent calculations are refined by the virtual controller 224 to simulate a set of future states of the autonomous vehicle 10 that result from attempting to follow the trajectory. These future states are used by the hypothesizer module(s) 212 to perform feed-forward predictions.

Various aspects of the cognitive processor 32 provide feedback loops. A first feedback loop is provided by the virtual controller 224. The virtual controller 224 simulates an operation of the autonomous vehicle 10 based on the provided trajectory and determines or predicts future states taken by each agent 50 in response to the trajectory taken by the autonomous vehicle 10. These future states of the agents can be provided to the hypothesizer modules as part of the first feedback loop.

A second feedback loop occurs because various modules will use historical information in their computations in order to learn and update parameters. Hypothesizer module(s) 212, for example, can implement their own buffers in order to store historical state data, whether the state data is from an observation or from a prediction (e.g., from the virtual controller 224). For example, in a hypothesizer module 212 that employs a kinematic regression tree, historical observation data for each agent is stored for several seconds and used in the computation for state predictions.

The hypothesis resolver 214 also has feedback in its design as it also utilizes historical information for computations. In this case, historical information about observations is used to compute prediction errors in time and to adapt hypothesis resolution parameters using the prediction errors. A sliding window can be used to select the historical information that is used for computing prediction errors and for learning hypothesis resolution parameters. For short term learning, the sliding window governs the update rate of the parameters of the hypothesis resolver 214. Over larger time scales, the prediction errors can be aggregated during a selected episode (such as a left turn episode) and used to update parameters after the episode.

The decision resolver 218 also uses historical information for feedback computations. Historical information about the performance of the autonomous vehicle trajectories is used to compute optimal decisions and to adapt decision resolution parameters accordingly. This learning can occur at the decision resolver 218 at multiple time scales. In a shortest time scale, information about performance is continuously computed using evaluator modules 232 and fed back to the decision resolver 218. For instance, an algorithm can be used to provide information on the performance of a trajectory provided by a decider module based on multiple metrics as well as other contextual information. This contextual information can be used as a reward signal in reinforcement learning processes for operating the decision resolver 218 over various time scales. Feedback can be asynchronous to the decision resolver 218, and the decision resolver 218 can adapt upon receiving the feedback.

In various embodiments, a cognitive system such as the cognitive processor 32 can be trained in order to operate the autonomous vehicle 10 in a manner that simulates or mimics the behavior of a human driver of the vehicle in various traffic situations. In other words, the cognitive system can be trained to propose an action or trajectory that is the same or substantially the same as an action or trajectory that would be taken by a human driver behind the wheel of the vehicle. The cognitive system can be trained by evaluating the operation of the cognitive system in a traffic scenario using one or more human-based evaluation techniques, as discussed herein.

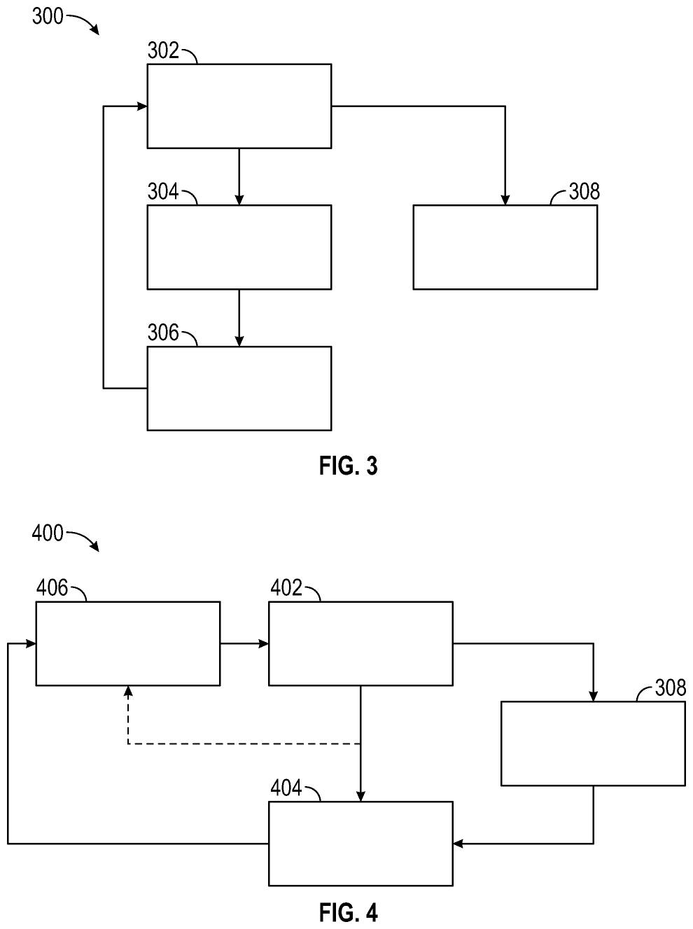

FIG. 3 shows a schematic diagram of a training system 300 for training a maneuver classifier 308 to be able to respond to a driving scenario by selecting a driving maneuver suitable to the driving scenario. The training system 300 includes a driving dataset 302 that serves as a training set of data, a clustering module 304 that clusters driving maneuvers, a labelling module 306 and the maneuver classifier 308. The training can be performed at an offline processor, or a processor outside of the autonomous vehicle.

The driving dataset 302 can be a simulated set of data or a historical data set in various embodiments. A historical data set can be, for example, an NGSIM (Next Generation Simulation) data set. The historical data can include data of traffic traversing a selected section of road during a selected time interval.

The clustering module 304 receives a driving context and selects data from the driving dataset 302 based on the driving context. A driving context can include turning maneuvers, the presence of other road users, the speed of the other road users, etc. The driving context can also include a speed and heading of a host vehicle represented in the data. The clustering module 304 clusters the data into maneuver clusters based on similarities in the maneuvers performed by the host vehicle, thereby allowing the processor to distinguish between individual maneuvers. The maneuver clusters are provided from the clustering module 304 to the labelling module 306.

The labelling module 306 assigns a label to each cluster in order to identify the type of driving maneuver represented by the cluster. The label for a driving maneuver can include, for example, a stop, a merge, an acceleration, a lane change, etc. In an embodiment, the labelling module 306 operates by presenting the maneuver clusters to a human and allowing the human to assign the label to each cluster. Once the labels have been assigned at the labelling module 306, the labels are then applied to the data of the driving dataset 302, thereby creating labelled training data. The labeled trained data is used to train the maneuver classifier 308 to be able select a driving maneuver based on a driving context (e.g., speed and heading of the autonomous vehicle 10).

FIG. 4 shows a schematic diagram of an operating system 400 that is using the trained maneuver classifier 308 to operate the autonomous vehicle 10 through different driving scenarios. The operating system 400 is operated at an online processor, or a processor of the autonomous vehicle 10. The operating system 400 includes the trained maneuver classifier 308 as well as an autonomous vehicle control module (AV control module 402), a performance grading module 404 and a compensation module 406. The AV control module 402 can represent the autonomous vehicle 10 or a control system that can be installed in an autonomous vehicle 10, in various embodiments. The AV control module 402 sends a speed and heading of the autonomous vehicle 10 to the maneuver classifier 308, which has been previously trained. The maneuver classifier 308 identifies the driving maneuver being performed based on the speed and heading of the autonomous vehicle 10 and provides the identified driving maneuver to the performance grading module 404. The performance grading module 404 also receives a full state of the autonomous vehicle, including not only the speed and heading of the autonomous vehicle 10, but also the acceleration/deceleration, steering angle, etc. The performance grading module 404 assigns a context specific performance grade to the driving maneuver based on the full state of the autonomous vehicle 10.

The context specific performance grade is provided to the compensation module 406 as well as the full state of the autonomous vehicle 10. The compensation module 406 reviews the context specific performance grade in view of the full state of the autonomous vehicle 10 and provides a feedback to the AV control module 402 based on the grade and vehicle state in order to provide an improved performance of the autonomous vehicle 10. The feedback can inform the AV control module 402 to change a state of the vehicle, such as a speed of the vehicle, an acceleration/deceleration of the vehicle, a heading of the vehicle, etc. The feedback can therefore be used to adjust the driving maneuver being currently performed such as to achieve an improved performance grade. The feedback can also be used to adjust a subsequent execution of the driving maneuver.

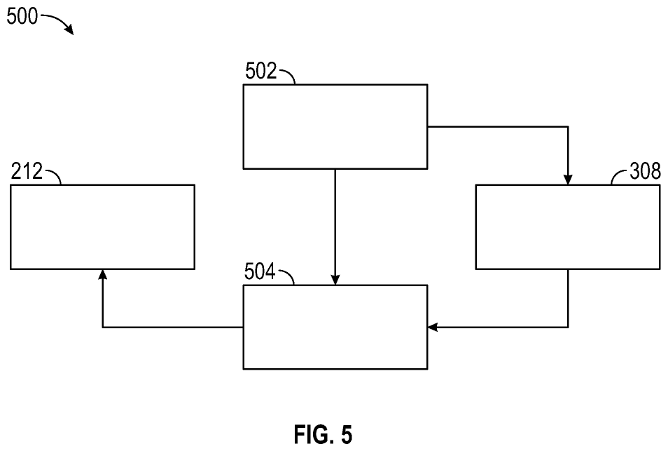

FIG. 5. shows a schematic diagram of a grading system 500 for grading the actions of other road users (ORUs) as evaluated using the maneuver classifier 308. The grading system 500 includes a sensor module 502, the trained maneuver classifier 308 and a ORU performance grading module 504, which can be the same performance grading module 404 of FIG. 4. The sensor module 502 determines or measures the speed and heading of the other road users. The speeds and headings are sent to the trained maneuver classifier 308 which identifies the driving maneuver that is being performed by the other road user based on the speed and heading of the other road user. The ORU performance grading module 504 assigns a context specific performance grade for each of the other road users and provides these grades (ORU grades) to the hypothesizer module 212 of the illustrative control system 200, FIG. 2. The hypothesizer module 212 uses these ORU grades to update its prediction of the trajectory of each of the other road users.

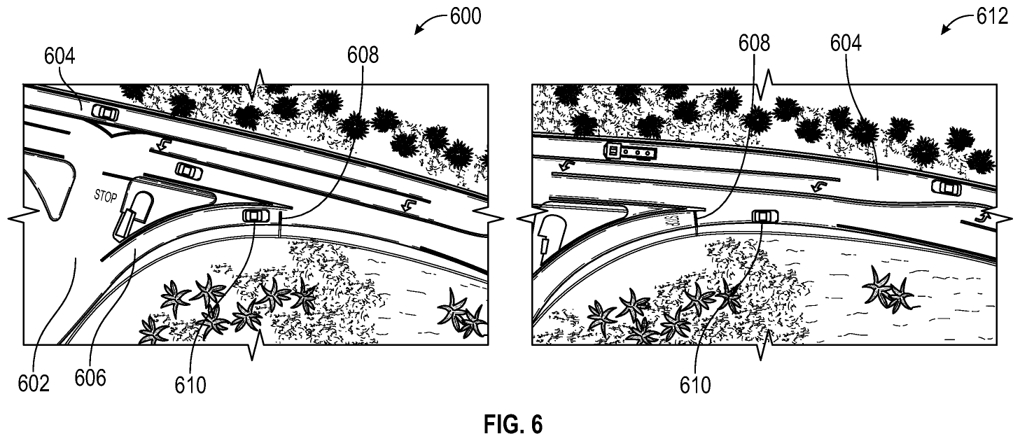

FIG. 6 shows illustrative data from a driving dataset 302 for a driving scenario in which a host vehicle 610 passes through an intersection. The dataset includes aerial snapshots of the intersection at a plurality of time steps. Snapshots illustrate a driving scenario in which the host vehicle 610 makes a turn. A first snapshot 600 shows a first road section 602 and a second road section 604 forming an intersection with the first road section. A right turn ramp 606 provides a lane by which vehicles can make a right turn from the first road section 602 to the second road section 604. In the first snapshot 600, the host vehicle 610 is coming to a stop at a stop line 608 on the right turn ramp 606. A second snapshot 612 shows the same intersection as in the first snapshot 600. In the second snapshot 612, the host vehicle 610 is accelerating away from the stop line 608 and onto a lane of the second road section 604.

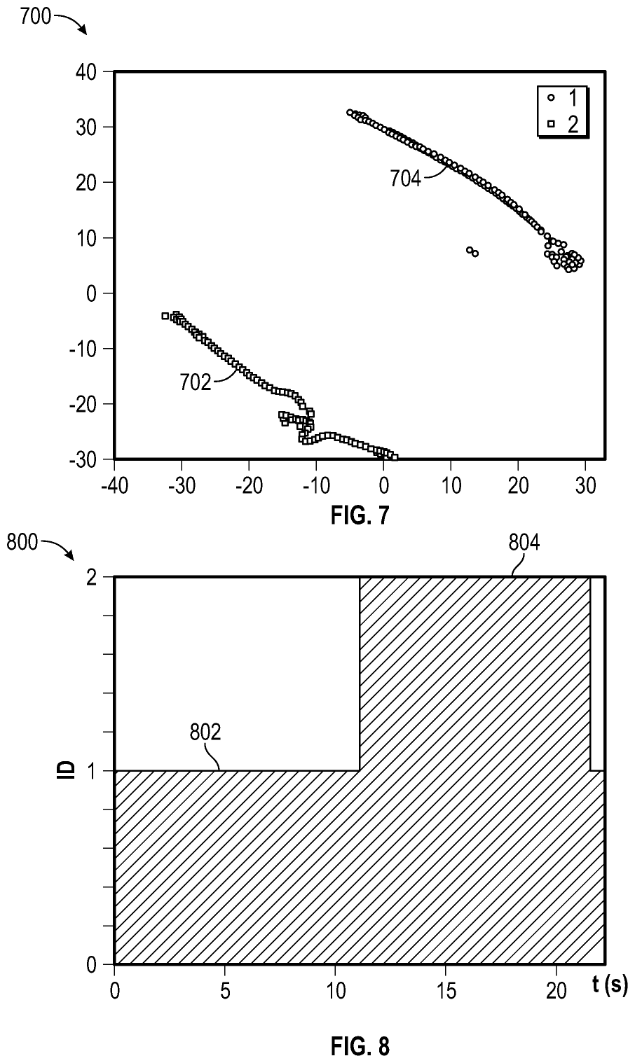

FIG. 7 shows a graph 700 depicting illustrative data clusters generated from a plurality of snapshots for a selected driving scenario, such as those snapshots shown in in FIG. 6, using a suitable clustering method. The data displays a plurality of speeds and headings for the host vehicle 610. The selected data therefore form a multi-dimensional set. The data selected from the dataset can be clustered using a suitable clustering method, such as a k-means clustering method, for example. The clustering method reduces the dimensions of the original dataset to a reduced dimensionality space, such as a two-dimensional space. Graph 700 shows a first cluster 702 and a second cluster 704 related to the driving scenario depicted in FIG. 6. The first cluster 702 is representative of a first driving maneuver of the autonomous vehicle, such as slowing to a stop, as illustrated in first snapshot 600. The second cluster 704 is representative of a second driving maneuver of the autonomous vehicle, such as accelerating onto the second road section 604, as illustrated in second snapshot 612.

FIG. 8 shows a graph 800 illustrating cluster assignment over time. Time is shown along the abscissa and cluster ID is shown along the ordinate axis. Each cluster is assigned a cluster ID in order to identify the driving maneuver being performed. A cluster ID of “1” indicates the driving maneuver in which the host vehicle 610 slows to a stop. A cluster ID of “2” indicates the driving maneuver in which the host vehicle 610 accelerates and merges onto the second road section 604. The graph 800 shows that the host vehicle 610 slows to a stop during a first time period 802 from 0 seconds to about 11 seconds and accelerates during a second time period 804 from about 11 seconds to about 21 seconds.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of operating an autonomous vehicle, comprising:
training a maneuver classifier to identify a driving maneuver for a driving context;
receiving the driving context at the maneuver classifier;
identifying the driving maneuver at the maneuver classifier based on the driving context;
performing the driving maneuver at the autonomous vehicle;
grading the driving maneuver as it is being performed at the autonomous vehicle to obtain a grade; and
adjusting a performance of the driving maneuver at the autonomous vehicle based on the grade.

2. The method of claim 1, wherein training the maneuver classifier comprises creating a cluster for each of a plurality of driving maneuvers identified from a historical database of driving maneuvers.

3. The method of claim 2, further comprising labelling the cluster of the plurality of driving maneuvers.

4. The method of claim 3, wherein the cluster is labelled by a human.

5. The method of claim 1, wherein the driving context includes a speed of the autonomous vehicle and a heading of the autonomous vehicle.

6. The method of claim 1, further comprising assigning a grade to a road user other than the autonomous vehicle and adjusting a prediction of a trajectory of the road user based on the grade for the road user.

7. The method of claim 1, wherein grading the driving maneuver further comprises assigning a performance grade specific to the driving context.

8. A system for operating an autonomous vehicle, comprising:
an offline processor configured to train a maneuver classifier to identify a driving maneuver for a driving context;
an online processor configured to:
receive the driving context;
operate the maneuver classifier to identify the driving maneuver based on the driving context;
perform the driving maneuver at the autonomous vehicle;
grade the driving maneuver as it is being performed at the autonomous vehicle; and
adjust a performance of the driving maneuver at the autonomous vehicle based on the grade.

9. The system of claim 8, wherein the offline processor is configured to train the maneuver classifier by creating a cluster for each of a plurality of driving maneuvers selected from a historical database of driving maneuvers.

10. The system of claim 9, wherein the offline processor is further configured to label the cluster of the plurality of driving maneuvers.

11. The system of claim 10, wherein the offline processor is further configured to receive a label for the cluster from a human.

12. The system of claim 8, wherein the online processor is further configured to receive, as the driving context, a speed of the autonomous vehicle and a heading of the autonomous vehicle.

13. The system of claim 8, wherein the online processor is further configured to assign a grade to a road user other than the autonomous vehicle and adjust a prediction of a trajectory of the road user based on the grade for the road user.

14. The system of claim 8, wherein the online processor is further configured to grade the driving maneuver by assigning a performance grade specific to the driving context.

15. An autonomous vehicle, comprising:
a maneuver classifier trained at an offline processor to identify a driving maneuver for a driving context;
an online processor configured to:
receive the driving context;
operate the maneuver classifier to identify the driving maneuver based on the driving context;
perform the driving maneuver at the autonomous vehicle;
grade the driving maneuver as it is being performed at the autonomous vehicle; and
adjust a performance of the driving maneuver at the autonomous vehicle based on the grade.

16. The autonomous vehicle of claim 15, wherein the offline processor is configured to create a cluster for each of a plurality of driving maneuvers selected from a historical database of driving maneuvers to train the maneuver classifier.

17. The autonomous vehicle of claim 16, wherein the offline processor is further configured to present the cluster of each of the plurality of driving maneuvers to a human and receive a label for the cluster from the human.

18. The autonomous vehicle of claim 15, wherein the online processor is further configured to receive, as the driving context, a speed of the autonomous vehicle and a heading of the autonomous vehicle.

19. The autonomous vehicle of claim 15, wherein the online processor is further configured to assign a grade to a road user other than the autonomous vehicle and adjust a prediction of a trajectory of the road user based on the grade for the road user.

20. The autonomous vehicle of claim 15, wherein the online processor is further configured to grade the driving maneuver by assigning a performance grade specific to the driving context.
